(19) United States
(12) Patent Application Publication
(10) Pub. No.: US 2014/0317881 A1
(43) Pub. Date: Oct. 30, 2014

(54) HINGING ELEMENT MANUFACTURED ON THE BASIS OF AT LEAST ONE PLANAR STRUCTURE AND A METHOD FOR MANUFACTURING A HINGING ELEMENT BASED ON AT LEAST ONE PLANAR STRUCTURE

(71) Applicants: Hans-Peter Heim, Guetersloh (DE); Nina Lieven, Wolfsburg (DE); Angela Ries, Kassel (DE); Dominik Sennhenn, Fritzlar (DE)

(72) Inventors: Hans-Peter Heim, Guetersloh (DE); Nina Lieven, Wolfsburg (DE); Angela Ries, Kassel (DE); Dominik Sennhenn, Fritzlar (DE)

(73) Assignee: Universitat Kassel, Kassel (DE)

(21) Appl. No.: 14/238,794

(22) PCT Filed: Jun. 9, 2012
(86) PCT No.: PCT/DE2012/000612

§ 371 Date: May 12, 2014

(30) Foreign Application Priority Data
Aug. 13, 2011 (DE) 10 2011 110 937.8

(51) Int. Cl. E05D 7/00; B29C 55/02

(52) U.S. Cl. CPC E05D 7/00; B29C 55/02; B29L 2031/22
USPC 16/221; 264/291

(57) ABSTRACT

A hinge element has at least one planar structure made of a thermoplastic material. Following a stretching process, the thermoplastic material undergoes a shrinking process under the effects of heat.

The invention relates on the one hand to a hinging element manufactured on the basis of at least one planar structure made of a material made of a thermoplastic, e.g. a film, a woven fabric, a non-crimp fabric, a warp-knitted fabric or a weft-knitted fabric and on the other hand to a method for manufacturing a hinging element based on at least one such planar stricture made of a thermoplastic.

In the following a hinging element must be understood as an articulation or an articulated connection between two articulation or hinge partners. The hinge partners serve for fixation on an object, e.g. a door. A hinge therefore includes hinge halves and a hinging element.

Hinge partners are known in principle from the prior art. More specifically, mechanical hinges are known for example in form of strap hinges, which are used in the furniture industry. In addition, so-called living hinges are known, such a living hinge being characterized in that it consists of a thin plastic material, the material of the living hinge being mostly identical to that of the hinge partners that are connected to each other by the living hinge, e.g. the connection between a cover and a box by a living hinge.

In this context, a hinging element designed as a strip made of a foil and/or a planar structure such as a woven fabric, a warp-knitted fabric and a non-crimp fabric is known from DE 201 20 819 U1. The hinging element consisting of a foil or a planar structure connects a cover part made of a fiber-glass reinforced thermoplastic with a flap also made of a fiber-glass reinforced thermoplastic for an opening in the cover part. The film or the planar structure forming the hinging element is made of a plastic material compatible with the thermoplastic of the cover part.

The strip forming the hinging element made of this plastic material is pressed into the cover part and into the flap. A hinging element manufactured from a woven fabric, a warp-knitted fabric or a non-crimp fabric is thus known. Hinging elements manufactured in this manner have only a very small resilience if at all.

However, under certain circumstances, there is a need to provide an articulation which tends to move back into an initial position after a deployment or pivoting movement, i.e. which has a pronounced resiliency. When mechanical hinges are used, they are for example spring-loaded.

The problem underlying the invention therefore consists in manufacturing a hinging element on the basis of a planar structure made of a material made of a thermoplastic having the desired resiliency.

A hinging element of the type mentioned in the introduction having such a resiliency is characterized in accordance with the invention in that the material made of a thermoplastic, which was first subjected to a stretching process then undergoes a shrinking process under the action of heat.

The initial material for the manufacture of a planar structure can be a film, threads, yarns, ribbons or filaments and/or a woven fabric, a warp-knitted fabric or a non-crimp fabric manufactured from threads, yarns, ribbons or filaments.

Advantageous features and embodiments of the invention can be gathered from the dependent claims.

When stretching the films, yarns, threads, ribbons or filaments, a longitudinal extension of the molecule chains is achieved by pulling. During the stretching operation, the length of the material is partially increased several times in several steps. The tensile strength and tensile rigidity thereby often also increases several times in the direction of stretching. This self-reinforcement can be brought about in a targeted manner by melt and/or solid phase deformation and is substantially based on creating oriented crystalline overlayer structures and on the orientation of the macromolecular chains. The stretching operation can also be implemented under the action of heat. If a film is heated up after the stretching operation, the film tends to shrink.

If another planar structure, e.g. a woven fabric, a warp-knitted fabric or a non-crimp fabric made of threads, yarns, ribbons or filaments, which has been subjected to a stretching operation before processing, e.g. into a woven fabric, is subsequently subjected to heat, such a planar structure also tends to shrink. It has turned out that a film, for example, that has first been stretched and has subsequently been subjected to a shrinking process under heat, tends to return after deformation to its initial position, which it has taken up after the shrinking operation has been completed. This means that as a rigid structure, a hinging element manufactured in this fashion from a film tends after deformation, e.g. by bending, to always return to its initial position. The same correspondingly applies to the other planar structures described above. This means that a planar structure, which is angled in its initial position will also tend to return to its initial position after its displacement. In this respect, planar structures which are created in a tool form that is not even but e.g. angled also fall under the invention.

A planar structure manufactured from e.g. threads, ribbons or yarns, e.g. a woven fabric can also be subjected to the stretching operation only after its creation. This means that the threads, yarns or filaments forming the planar structure are stretched as a planar structure. A planar structure processed in this manner will also shrink under the action of heat. It is also conceivable and it is also covered by the invention to stretch threads or yarns forming the planar structure and to subsequently again subject the planar structure manufactured herefrom to one or several stretching operations. Such a planar structure will also shrink under repeated action of heat. However, the planar structures themselves can also be made of different materials. Thus, in a woven fabric for example it is conceivable to manufacture the warp and the weft threads from threads and ribbons, wherein the threads and ribbons are or can additionally be made of different thermoplastics.

The planar structures for manufacturing a hinging element can be manufactured e.g. from threads, yarns or ribbons of different materials or of the same materials but have e.g. different cross-sections or from a combination of both. The hinge element can also include several planar structures disposed above one another and connected to each other, wherein the planar structures themselves can be different with respect to their type and material. Thus, it is conceivable to combine a woven fabric with a foil in order to form a smooth surface of the fabric or to form a colored hinge by means of the foil, irrespective of the fact that as a planar structure the foil also supports the reset function of the hinge element. The connection of several planar structures for forming a hinge element can be implemented e.g. by sewing or gluing.

Another object of the invention is a method for manufacturing a hinging element based on a planar structure, e.g. a film, a woven fabric, a non-crimp fabric or a warp-knitted fabric made of thermoplastic, the planar structure and/or the threads, yarns, ribbons or filaments forming the planar structure being subjected to at least one stretching operation, the planar structure being heated in a tool form, the planar structure going through a shrinking operation in the tool form during the cooling phase. In the method too, it is assumed that the planar structure, e.g. a film or a woven fabric, is stretched as a whole or that the individual threads, yams or filaments are stretched before being processed to form the planar structure and then subjected to the shrinking operation, or that the planar structure already manufactured from stretched threads, yarns or filaments is subjected to another or several other stretching operations before the shrinking operation. This implies the following:

The planar structure is laid in a tool form with a bottom form part and a top form part in form of a die tool, the planar structure being heated under pressure in the tool form, preferably until the melt temperature of the thermoplastic is reached or beyond. In addition, planar structures can be laid between the hinge partners, in order to form a hinge. However, it is also conceivable to transform the hinging element into a hinge by fastening the hinging element directly on e.g. a cover and a box in the manner of a living hinge. At melt temperature, a connection of the planar structure with hinge partners, which serve to connect the hinge to a cupboard, for example, can also be implemented. Hereby, a material bond with the respective hinge partner is formed. The planar structures can be located above or below the hinge partners. In order to stabilize the planar structure between hinge partners, the space between the planar structures can be filled with another planar structure. Such a measure more specifically has an effect with hinge partners with a great cross-section.

During the cooling phase, the planar structure is unloaded to a point where the planar structure can shrink but where the texture of its surface does not or not substantially change. This means that by opening the tool form the planar structure is ultimately minimally unloaded so that it can go through the desired shrinking operation but cannot be deformed in any other way, i.e. does not become wavy or distorted.

In the following, the invention is exemplarily described in more detail based on the drawings.

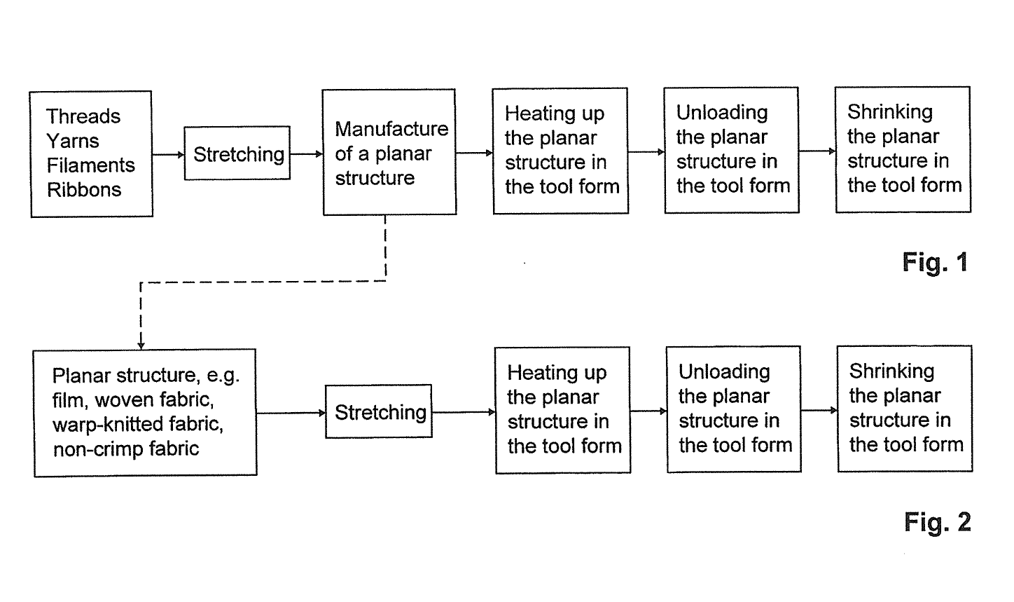

FIG. 1 schematically shows the process for manufacturing a hinging element from individual threads, yarns or filaments;

FIG. 2 shows the manufacture of a hinging element from a planar structure, e.g. a film, a woven fabric, a non-crimp fabric or a warp-knitted fabric, wherein a planar structure can also consist of already stretched threads, yams or filaments according to FIG. 1;

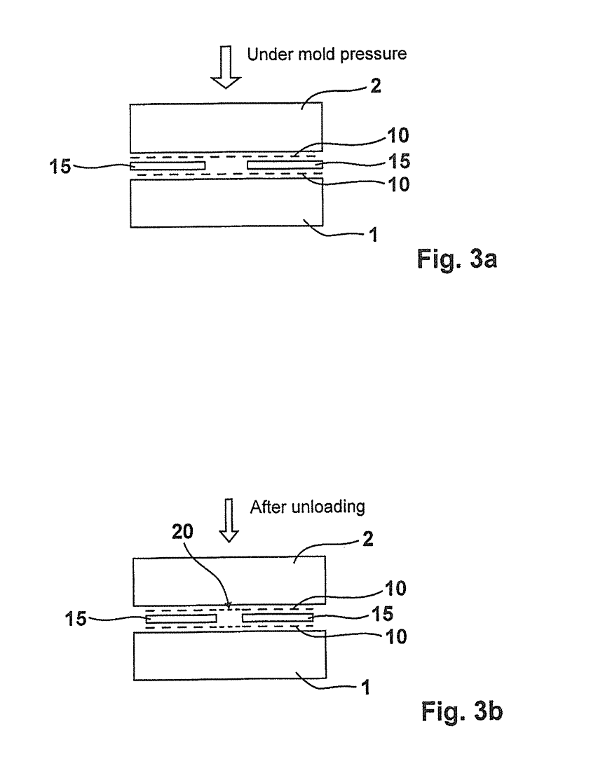

FIG. 3a, 3b schematically show a tool form with inlaid planar structures between which hinge partners are provided;

As can be gathered from FIG. 1, individual threads, yarns or filaments are subjected to one or several successive stretching operations. Such a stretching, more specifically under the action of heat, leads to an orientation of the macromolecular chains of the thermoplastic, which leads to an increase in tensile strength. This principle is known from the prior art. After manufacturing the planar structure from such stretched threads, yams or filaments, the planar structure is heated up in a tool form under a pressure acting on the planar structure until the melt temperature of the thermoplastic is reached or beyond, wherein, during the cooling operation, the planar structure is subsequently allowed to shrink in the tool form, namely while substantially maintaining its original shape in the tool form. If a planar structure is provided e.g. in form of a non-stretched film or of a woven fabric, non-crimp fabric or warp-knitted fabric, wherein the individual threads of e.g. such a woven fabric have not been subjected to a stretching process, this planar surface is first subjected to a stretching process (FIG. 2), wherein such a stretching process can also be implemented several times in succession, in order to achieve a corresponding increase in tensile strength. The planar structure is then heated in the tool form until the melt temperature of the plastic is reached or beyond. A material bond with the hinge partner is thereby also formed if necessary. The hinge partner can be a screw plate for example in order to be able to fasten such a hinge to a cupboard for example. During the cooling phase, the planar structure is allowed to shrink, as has been explained above, when the planar structure in the tool form is unloaded. The load removal must be such that the planar structure can contract but without forming waves for example, i.e. cannot be distorted. FIG. 1 and FIG. 2 also disclose a combination in which the e.g. ribbons of a woven fabric are stretched after being processed to form a woven fabric, the woven fabric as such being subsequently subjected to a stretching operation before being heated up to melt temperature.

FIG. 3a and FIG. 3b exemplarily show such a tool form, the bottom form part being labeled 1 and the top form part configured as a die tool being labeled 2. Two stretched planar structures 10 disposed in a spaced-apart relationship are located between the die tool 2 and the bottom form part 1, two hinge partners 15 being disposed between the planar structures. Another planar structure can be laid in between hinge partners for filling the space between the planar structures disposed above one another. After heating up the planar structure made of a thermoplastic, e.g. a polypropylene, a polyethylene or a polyamide, to the melt temperature of this thermoplastic in the tool form while applying a pressure on the upper side of the planar structure, the die tool is lifted during the cooling phase to a point where the planar structures are no longer loaded by the die tool, so that the planar structures contract, i.e. can shrink (FIG. 3b). This shrinking operation does not occur in the area of the hinge partners but between them (arrow 20). It is sufficient if the die tool is lifted by a few tenths or hundredths millimeters. In any event, it is important that the planar structures substantially maintain their outer surface contour, i.e. do not become wavy during the shrinking process. It does not matter whether the planar structures are laid at an angle or straight in a correspondingly configured tool form. The only determining factor is that after heating, the pressure is reduced during the cooling phase to a point where a shrinking process can occur without the surface of the respective planar surface substantially changing during the shrinking process.

A hinge composed of planar surfaces and hinge partners manufactured in such a manner is characterized, as has already been explained, by a great resiliency, which means that such a hinge always tends to retake its original shape after having been displaced in a bending operation.

If the hinge partners are not connected to the planar structure(s) during the heat treatment of the planar structure(s), the finished planar structures (=hinging elements) can also be subsequently brought in connection with the hinge partners, e.g. mechanically by screwing or by a material bond by welding or gluing. Together with the hinging element, the hinge partners form the hinge, wherein the hinge partners allow for connection to a cupboard for example.

In the following, the process parameters that must be observed in a process for manufacturing a hinge in order to obtain a resiliency of a woven fabric made of polypropylene (PP) are described. The melt temperature of PP is approximately 165° C. The ribbons of the woven fabric have been stretched before processing into a woven fabric.

In a 1st step, the woven fabric is heated in a tool form under a pressure of ca. 100 kN up to ca. 177° C. and stabilized during 30 seconds (step 2). It is then cooled down to ca. 150° C. for a duration of 60 sec. at a pressure of 100 kN (3^{rd} step).

In a 4^{th} step the woven fabric in the tool form is unloaded (0 kN) and cooled down to 100° C. during 500 sec. The finished hinge can then be removed. During the process, the hinge partners can be connected to the planar structure during the first and second step.

### LIST OF REFERENCE NUMBERS

1 bottom form part
2 die tool (top form part)
10 planar structure
15 hinge partner
20 arrow

1-12. (canceled)

13. A hinging element, comprising:
at least one planar structure made of thermoplastic material;
wherein the thermoplastic material is stretched and is then subjected to a shrinking process under the action of heat.

14. A hinging element in accordance with claim 14, wherein:
the thermoplastic material is a film, threads, yams, ribbons or filaments or woven fabric, warp-knitted fabric or non-crimp fabric.

15. A hinging element in accordance with claim 15, wherein:
the thermoplastic material is a woven fabric, warp-knitted fabric or non-crimp fabric formed by threads, yarns or filaments, and the threads, yarns, ribbons or filaments have undergone a stretching process before being processed into the woven fabric, warp-knitted fabric or non-crimp fabric.

16. A hinging element in accordance with claim 15, wherein:
the thermoplastic material is a woven fabric, warp-knitted fabric or non-crimp fabric and the woven fabric, the warp-knitted fabric or the non-crimp fabric has undergone a stretching process.

17. A hinging element in accordance with claim 17, wherein:
the stretching process includes one or several stretching operations.

18. A hinging element in accordance with claim 18, wherein:
the stretching operation occurs under the action of heat.

19. A hinging element in accordance with claim 14, wherein:
the at least one planar structure comprises a plurality of planar structures disposed above one another; and
the plurality of planar structures include more than one type of structure, the types being selected from a group consisting of film, threads, yams, ribbons or filaments, or woven fabric, warp-knitted fabric or non-crimp fabric formed by threads, yarns or filaments.

20. A hinging element in accordance with claim 14, wherein:
the at least one planar structure comprises a plurality of planar structures disposed above one another; and
the plurality of planar structures each being formed of thermoplastic, the plurality of planar structures including more than one type of thermoplastic

21. A hinging element in accordance with claim 14, wherein:
the at least one planar structure is made of threads, yarns, ribbons or filaments from different thermoplastics.

22. A hinging element in accordance with claim 14, wherein:
the thermoplastic material is a threads, yarns, ribbons or filaments; and
more than one type of the threads, yams, ribbons or filaments are combined within one planar structure.

23. A method for manufacturing a hinging element in accordance with claim 14, wherein:
the at least one planar structure is formed of threads, yarns, ribbons or filaments;
the method comprising;
subjecting the threads, yards, ribbons or filaments to at least one stretching operation;
heating the at least one planar structure in a tool form; and
shrinking the at least one planar structure in the tool form during a cooling phase.

24. A method in accordance with claim 24, wherein:
the at least one planar structure is under pressure in the closed tool form during the heating phase; and
the tool form is opened during the cooling phase to a point where the at least one planar structure can shrink but substantially maintains its initial shape with regard to its surface.

25. A method in accordance with claim 24, wherein:
the at least one planar structure is heated up to the melt temperature of the thermoplastic or beyond during the heating step.
